(19) United States
(12) Patent Application Publication
(10) Pub. No.: US 2015/0033210 A1
(43) Pub. Date: Jan. 29, 2015

(54) METHOD AND SYSTEM FOR DEBUGGING A CHANGE-SET

(71) Applicant: International Business Machines Corporation, Armonk, NY (US)

(72) Inventors: Marlin R. Deckert, San Jose, CA (US); Si Bin Fan, Beijing (CN); Yan Zhao, Beijing (CN)

(73) Assignee: International Business Machines Corporation, Armonk, NY (US)

(21) Appl. No.: 14/205,536

(22) Filed: Mar. 12, 2014

(30) Foreign Application Priority Data
Jul. 29, 2013 (CN) 201310322330.8

(51) Int. Cl. G06F 11/36

(52) U.S. Cl. CPC G06F 11/362
USPC 717/129

(57) ABSTRACT

Exemplary embodiment of include methods and systems for debugging a change-set. The method includes obtaining a change-set for debugging; calculating a code change region by using the change-set and generating breakpoints for debugging the change-set based on the code change region. In exemplary embodiments, breakpoints in a change-set can be set quickly and effectively.

### CROSS-REFERENCE TO RELATED APPLICATION

This application claims priority to Chinese Application No. 201310322330.8, filed 29, Jul., 2013, and all the benefits accruing therefrom under 35 U.S.C. §119, the contents of which in its entirety are herein incorporated by reference.

### BACKGROUND

The present invention relates generally to data processing, and more particularly, to a method and system for debugging a change-set.

Software configuration management refers to ensure integrity and traceability of all configuration items by performing version control, changing control specification, and using proper configuration management software, it is an effective protection for work product. Software configuration management can handle changes systematically, such that a software system can maintain its integrity at any time.

In software configuration management, a change-set refers to combination of a series of inseparable changes, such as a change-set caused by a work item, a change-set caused by a defect, etc. A change-set includes which files have been changed and file versions resulted from the changes, and user can obtain the changed content through file version comparison.

During software development, a developer usually needs to debug a change-set, however, setting breakpoints is often very time-consuming and tedious while debugging a change-set.

### SUMMARY

According to one embodiment a method for debugging a change-set includes obtaining a change-set for debugging, calculating a code change region by using the change-set, and generating breakpoints for debugging based on the code change region.

According to one embodiment a computer system for debugging a change-set includes a processor configured to obtain a change-set for debugging, calculate a code change region by using the change-set, and generate breakpoints for debugging based on the code change region.

According to another embodiment, calculating a code change region by using the change-set includes calculating an initial code change region corresponding to the change-set, detecting whether the initial code change region has been modified by any other subsequent change-set, and updating the initial code change region with the modification if it has been modified.

With the method and system for debugging according to the illustrative embodiments, breakpoints can be set quickly and effectively by integrating software configuration management with debugger, so that the above problems are better solved.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows a block diagram of an exemplary computer system/server 12 in accordance with an exemplary embodiment;

FIG. 2 shows a flowchart of a method 200 for debugging a change-set in accordance with an exemplary embodiment; and

FIG. 3 shows a block diagram of a system 300 for debugging a change-set in accordance with an exemplary embodiment.

### DETAILED DESCRIPTION

Exemplary embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

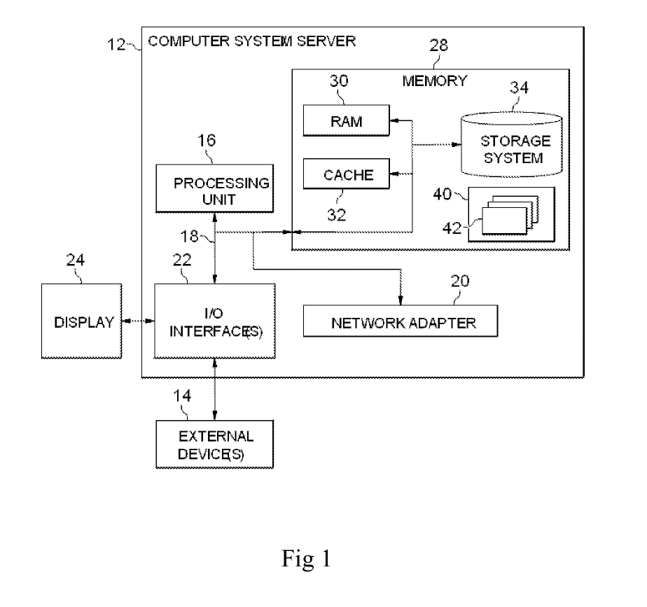

Referring now to FIG. 1, in which a block diagram of an exemplary computer system/server 12 in accordance with an exemplary embodiment is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In addition to conventional computer system/server 12 as shown in FIG. 1, mobile electronic device may also be applied to achieve embodiment of the invention, including but not being limited to, mobile telephone, PDA, tablet computer and others. Typically, mobile electronic device has input device, including but not being limited to, touch input device, such as, touch screen, touch tablet and others.

An exemplary embodiment will be described by taking two change-sets C1 and C2 for example. It should be appreciated that, the description herein is merely for illustration and should not be construed as to limit the scope to be protected by the invention. Assuming for a file my.cpp, initial state of its codes is version 1 (Ver.1), as shown in the following:

56 ...
57 if (hasValue(a)) {
58 doProcess(a);
59 }
60 ...

After change-set C1 has been applied, this file is changed to version 2 (Ver.2), as shown below, wherein lines 59-62 is a code change region corresponding to change-set C1, the corresponding change-set C1 is {my.app, ver.1, ver.2}:

56 ...
57 if (hasValue(a)) {
58 doProcess(a);
59 doUpdateCache( )
60 }
61 else {
62 doProcess(b);
63 }
64 ...

Afterwards, after change-set C2 has been applied, this file is changed to version 3 (Ver.3), as shown below, wherein lines 59-65 is a code change region corresponding to change-set C1 and lines 61-63 is a code change region corresponding to change-set C2, the corresponding change-set C2 is {my.app, ver.2, ver.3}:

56 ...
57 if (hasValue(a)) {
58 doProcess(a);
59 doUpdateCache( )
60 }
61 else if (hasValue(c)) {
62 doProcess(c);
63 }
64 else {
65 doProcess(b);
66 }
67 ...

The above procedure may be simply described through illustration, i.e., Ver.1 (C1) Ver. 2 (C2) Ver. 3, wherein“→(C1)→” represents the change made by change-set C1, “→(C2)→” represents the change made by change-set C2.

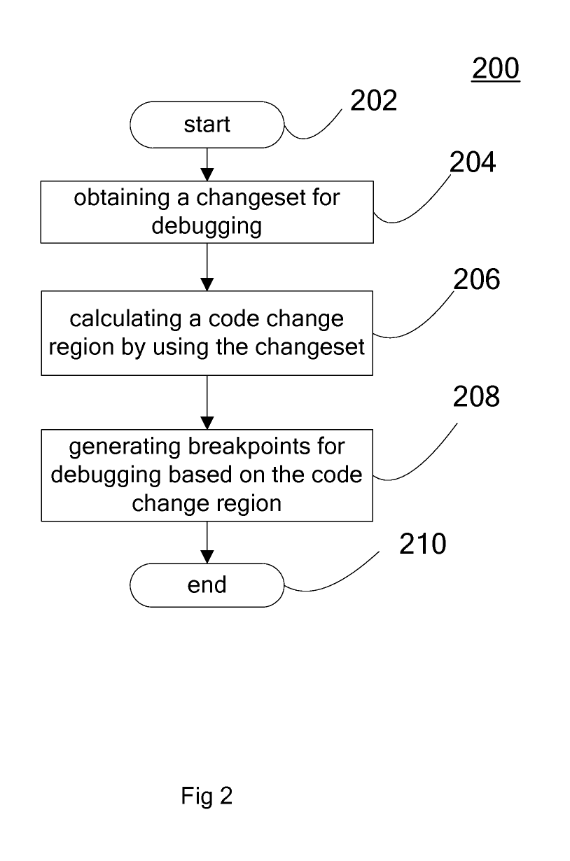

Referring now to FIG. 2, a flowchart of a method 200 for debugging a change-set in accordance with an exemplary embodiment is shown. As illustrated, the method 200 for begins at block 202. Next, the method 200 proceeds to block 204 of obtaining a change-set for debugging. In exemplary embodiments, the change-set may be set by a developer. For example, for the above example, the developer may select either C1 or C2 as a change-set for debugging.

Next, as shown at block 206, the method 200 includes calculating a code change region by using the change-set. According to an embodiment, an initial code change region corresponding to the change-set may be calculated and then it is detected whether the initial code change region has been modified by any other subsequent change-set. If so, the initial code change region is updated by using the modification made by other subsequent change-set. Taking the above illustration for example, assuming a developer has selected C1 as a change-set for debugging, first, an initial code change region corresponding to the change-set C1 is calculated. The initial code change region may be obtained by comparing versions of file corresponding to the change-set C1, and its result is the underlined portion in version 2, i.e. lines 59-62. Then, it is detected whether the initial code change region has been changed by any other subsequent change-set. Through detection, it is found that the initial code change region has been changed by a subsequent change-set C2, thus, the initial code region is updated by using the modification made by change-set C2, and its result is the underlined portion in version 3, i.e. lines 59-65.

Next, as shown at block 208, the method includes generating breakpoints for debugging the change-set based on the code change region. According to an embodiment, control flow analysis is performed on the code change region to determine entry points to the flow, and start line of the code change region and each of the determined entry points are set as breakpoints. Wherein, the breakpoints for debugging the change-set include a series of line breakpoints capable of being enabled or disabled individually and can be enabled or disabled as a whole. These line breakpoints are labeled as change-set line breakpoint, and during debugging, user may choose to run to a next change-set line breakpoint and ignore other ordinary line breakpoints. The control flow analysis is a common technology in the art, and description of which will be omitted for brevity. While generating breakpoints for debugging the change-set based on the code change region, it should be noted that: 1) a code comment line and other lines for which a breakpoint could not be set can not be set as breakpoint; 2) a code change region may extend to adjacent line(s) or other location as needed, for example, if a code change region changes assignment of a variable, then a breakpoint will be set at the location where this variable is used, although the location using the variable may not be within the code change region; 3) multiple breakpoints will be set if a code change region spans a plurality of functions or classes; 4) multiple breakpoints will be set if a code change region adds a branch.

Taking the above determined code change region (lines 59-65) for example, by performing control flow analysis on lines 59-65 of the code change region, it may be determined that entry points are line 59, line 62 and line 65. Then, start line of the code change region (here, it is line 59, which is coincide with the determined first entry point) and each of the determined entry points (line 59, line 62 and line 65) are set as breakpoint. In this way, setting of breakpoints for change-set C1 is completed, which include line breakpoints set in line 59, line 62 and line 65.

The above description is merely a simple illustration, wherein, both change-sets C1, C2 have only changed a portion of a file. However, in practice, a change-set may change multiple portions of a file or may change multiple portions of multiple files; and user may choose to debug one change-set or may choose to debug multiple change-sets. As shown at block 210, the method 200 ends after completion of generating breakpoints for debugging the change-set based on the code change region.

The method 200 for debugging a change-set according to an embodiment of the invention has been described in detail with reference to the example of FIG. 2. According to an embodiment of the invention, the method 200 for debugging may also include outputting the generated breakpoints for debugging the change-set. The generated breakpoints are outputted to a debugger, and then the change-set is debugged by the debugger according to the generated breakpoints. According to an embodiment of the invention, the method 200 for debugging may further include receiving file version information outputted by a debugger, obtaining files of each version corresponding to the file version information. While the change-set is debugged by the debugger according to the generated breakpoints, for the interested portion, the debugger outputs its corresponding file version information. When file version information is received, files of each version corresponding to the file version information may be obtained to be used in subsequent procedure.

According to an embodiment of the invention, the method 200 for debugging may also include calculating differences among files of each version corresponding to the file version information, outputting the differences for displaying. As stated above, after obtaining files of each version corresponding to the file version information, differences among files of each version corresponding to the file version information may be calculated and are outputted to the debugger for displaying by the debugger. In this way, differences among files of each version may be displayed clearly and intuitively, and a version comparison function can be provided to the developer, thereby improving efficiency in debugging.

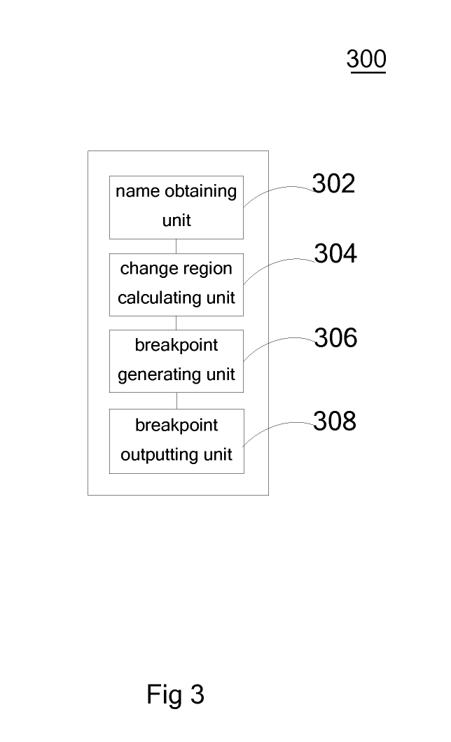

Referring now to FIG. 3, a block diagram of a system 300 for debugging a change-set in accordance with an exemplary embodiment is shown. The system 300 for debugging according to an embodiment of the invention includes a name obtaining unit 302 configured to obtain a change-set for debugging, a change region calculating unit 304 configured to calculate a code change region by using the change-set, and a breakpoint generating unit 306 configured to generate breakpoints for debugging the change-set based on the code change region. In exemplary embodiments, the a name obtaining unit 302, the change region calculating unit 304, and the breakpoint generating unit 306 may be part of a single processing unit or may be disposed in separate processing unit.

In an exemplary embodiment, the change region calculating unit 304 is further configured to calculate an initial code change region corresponding to the change-set, detect whether the initial code change region has been modified by any other subsequent change-set, and update the initial code change region with the modification if it has been modified.

In an exemplary embodiment, the breakpoint generating unit 306 is further configured to perform control flow analysis on the code change region to determine entry points to the flow and set a start line of the code change region and each of the determined entry points as breakpoint. The breakpoints include a series of line breakpoints capable of being enabled or disabled individually and can be enabled or disabled as a whole.

In an exemplary embodiment, the system 300 further includes a breakpoint outputting unit 308 configured to output the generated breakpoints for debugging the change-set. In an exemplary embodiment, the system 300 further includes a receiving unit (not shown) configured to receive file version information outputted by a debugger; a file obtaining unit (not shown) configured to obtain files of each version corresponding to the file version information. In an exemplary embodiment, the system 300 also includes a difference calculating unit (not shown) configured to calculate differences among files of each version corresponding to the file version information and a difference outputting unit (not shown) configured to output the differences for displaying.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for debugging a change-set comprising:
obtaining the change-set for debugging;
calculating a code change region by using the change-set; and
generating breakpoints for debugging the change-set based on the code change region.

2. The method according to claim 1, wherein calculating a code change region by using the change-set further comprises:
calculating an initial code change region corresponding to the change-set;
detecting whether the initial code change region has been modified by any other subsequent change-set; and
updating the initial code change region with the modification if it has been modified.

3. The method according to claim 1, wherein generating breakpoints for debugging the change-set based on the code change region further comprises:
performing control flow analysis on the code change region to determine entry points to the flow; and
setting start line of the code change region and each of the determined entry points as breakpoint.

4. The method according to claim 1, wherein the breakpoints for debugging the change-set comprise a series of line breakpoints capable of being enabled or disabled individually; and can be enabled or disabled as a whole.

5. The method according to claim 1, further comprising outputting the generated breakpoints for debugging the change-set.

6. The method according to claim 5, further comprising:
receiving file version information outputted by a debugger; and
obtaining files of each version corresponding to the file version information.

7. The method according to claim 6, further comprising:
calculating differences among files of each version corresponding to the file version information; and
outputting the differences for displaying.

8. A computer system for debugging a change-set, the computer system comprising a processor configured to:
obtain the change-set for debugging;
calculate a code change region by using the change-set; and
generate breakpoints for debugging the change-set based on the code change region.

9. The computer system according to claim 8, wherein the processor is further configured to:
calculate an initial code change region corresponding to the change-set;
detect whether the initial code change region has been modified by any other subsequent change-set; and
update the initial code change region with the modification if it has been modified.

10. The computer system according to claim 8, wherein the processor is further configured to:
perform control flow analysis on the code change region to determine entry points to the flow; and
set start line of the code change region and each of the determined entry points as breakpoint.

11. The computer system according to claim 8, wherein the breakpoints for debugging the change-set comprise a series of line breakpoints capable of being enabled or disabled individually; and can be enabled or disabled as a whole.

12. The computer system according to claim 8, wherein the processor is further configured to output the generated breakpoints for debugging the change-set.

13. The computer system according to claim 12, wherein the processor is further configured to:
receive file version information outputted by a debugger; and
obtain files of each version corresponding to the file version information.

14. The computer system according to claim 13, wherein the processor is further configured to:
calculate differences among files of each version corresponding to the file version information; and
output the differences for displaying.

15. A computer program product for debugging a change-set, the computer program product comprising:
a tangible storage medium readable by a processing circuit and storing instructions for execution by the processing circuit for performing a method comprising:
obtaining the change-set for debugging;
calculating a code change region by using the change-set; and
generating breakpoints for debugging the change-set based on the code change region.

16. The computer program product according to claim 15, wherein calculating a code change region by using the change-set further comprises:
calculating an initial code change region corresponding to the change-set;
detecting whether the initial code change region has been modified by any other subsequent change-set; and
updating the initial code change region with the modification if it has been modified.

17. The computer program product according to claim 15, wherein generating breakpoints for debugging the change-set based on the code change region further comprises:
performing control flow analysis on the code change region to determine entry points to the flow; and
setting start line of the code change region and each of the determined entry points as breakpoint.

18. The computer program product according to claim 15, wherein the breakpoints for debugging the change-set comprise a series of line breakpoints capable of being enabled or disabled individually; and can be enabled or disabled as a whole.

19. The computer program product according to claim 15, further comprising outputting the generated breakpoints for debugging the change-set.

20. The computer program product according to claim 19, further comprising:
receiving file version information outputted by a debugger; and
obtaining files of each version corresponding to the file version information.
